(19) United States
(12) Patent Application Publication
(10) Pub. No.: US 2007/0011429 A1
(43) Pub. Date: Jan. 11, 2007

(54) Virtual memory key generation

(76) Inventors: Vasudevan Sangili, San Jose, CA (US); Saleem Mohideen, Saratoga, CA (US); Hari Ganapathy, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/176,121

(22) Filed: Jul. 7, 2005

(51) Int. Cl. G06F 12/00

(52) U.S. Cl. 711/203

(57) ABSTRACT

Methods, computer readable media, and computing devices including program instructions are provided for virtual memory key generation. One method embodiment includes selecting a memory location that has a virtual memory address and a unique descriptor, assigned to it. The method includes generating a key for identifying the memory location, by using the virtual memory address and the unique descriptor.

### BACKGROUND

Before a computing device may accomplish a desired task, it must receive an appropriate set of instructions. Executed by a device's processor(s), these instructions direct the operation of the device. These instructions can be stored in a memory of the computer. Instructions can invoke other instructions.

A computing device, such as a server, router, desktop computer, laptop, etc., and other devices having processor logic and memory, includes an operating system layer and an application layer to enable the device to perform various functions or roles. The operating system layer includes a “kernel” (i.e., master control program) that runs the computing device. The kernel provides task management, device management, and data management, among others. The kernel sets the standards for application programs that run on the computing device and controls resources used by application programs. The application layer includes programs, i.e., executable instructions, which are located above the operating system layer and accessible by a user. As used herein, “user space”, “user-mode”, or “application space” implies a layer of code which is less privileged and more directly accessible by users than the layer of code which is in the operating system layer or “kernel” space.

When the execution of the program instructions call for data or other program instructions, the program will want to know where in memory the data or instructions are stored. In effect, the program will use a means for referencing or indexing where in memory the data or instructions are held. This work is done as part of the virtual memory subsystem of the operating system. In virtual memory, a process has a logical view of memory that does not correspond to the actual layout of physical memory. When a process uses a virtual memory address the virtual memory system translates it into a physical address using a virtual to physical address mapping contained in some type of look up structure and address mapping database.

The kernel manages various data structures within virtual memory, such as virtual address spaces, pregions, and regions. A virtual address space contains a set of pregions, which are associated with regions. Each pregion is linked to a region which has further information about access to a particular range of addresses within an address space. A region contains one or more pages that have virtual memory locations, in which data or instructions can be stored. A private region is associated with a pregion from one process and a shared region is associated with pregions from more than one process. A virtual memory location in a private region is a private virtual memory location and a virtual memory location in a shared region is a shared virtual memory location.

The location of a virtual memory location can be identified or described in various ways. A virtual memory address, associated with or assigned to a virtual memory location, identifies or describes the general location within a virtual memory. A descriptor, associated with or assigned to a virtual memory location, identifies or describes the specific location of its virtual memory location within a virtual memory. A unique descriptor is the sole descriptor for its virtual memory location. The term descriptor and/or unique descriptor as used herein is a “space id”. The term space id will be appreciated by one familiar with the art of virtual memory management. As will be appreciated, a space id is generated and maintained by the virtual memory subsystem of the operating system. A space id is associated with each virtual memory address.

As the user space virtual memory addresses are not unique addresses like kernel virtual memory addresses, a key is generated for these virtual addresses when the user space applications enter kernel space to wait for a particular event or resource. This key is used to identify the specific location of a virtual memory location within a virtual memory. To generate the key, the program instructions search through a virtual address space of the given process to locate the pregion that corresponds to the virtual memory address. While the program instructions search, the virtual address space is locked to prevent data in the virtual memory from being changed and/or moved. Once the program instructions find the pregion that corresponds to the virtual memory address, the program instructions can generate a key for identifying the specific location of the virtual memory location using the pregion and region information. After the program instructions have found or traversed through the entire virtual memory space, the virtual address space is unlocked.

When a virtual address space is locked, the use of the space is restricted. While locked, no process can write to the virtual address space and some processes may not be able to read from the virtual address space. These restrictions can limit the efficiency of processes that use the virtual address space. This may be particularly detrimental when the process has a large virtual address space.

### BRIEF DESCRIPTION OF THE DRAWINGS

FIG. 1 illustrates an example of a computing device suitable to implement embodiments of the present disclosure.

FIG. 2 illustrates a computing device including an embodiment of a key generation functionality that can interact with a virtual memory address and a unique descriptor.

FIG. 3 illustrates a virtual memory structure, including a shared region, suitable to implement embodiments of the present disclosure.

FIG. 4 illustrates an example of a shared region without a unique descriptor.

FIG. 5 is a block diagram of a method embodiment.

### DETAILED DESCRIPTION

Embodiments include systems, methods, and devices, including executable program instructions, for virtual memory key generation. One method embodiment includes selecting a virtual memory location that has a virtual memory address and a unique descriptor, assigned to it. According to various embodiments program instructions execute to generate a key for identifying the virtual memory location using the virtual memory address and the unique descriptor.

According to various embodiments, a key, for identifying the specific location of a virtual memory location within a virtual memory, can be generated without locking a virtual address space, processes can write to and read from the virtual address space, thus removing restrictions that would otherwise limit their efficient use of the virtual address space.

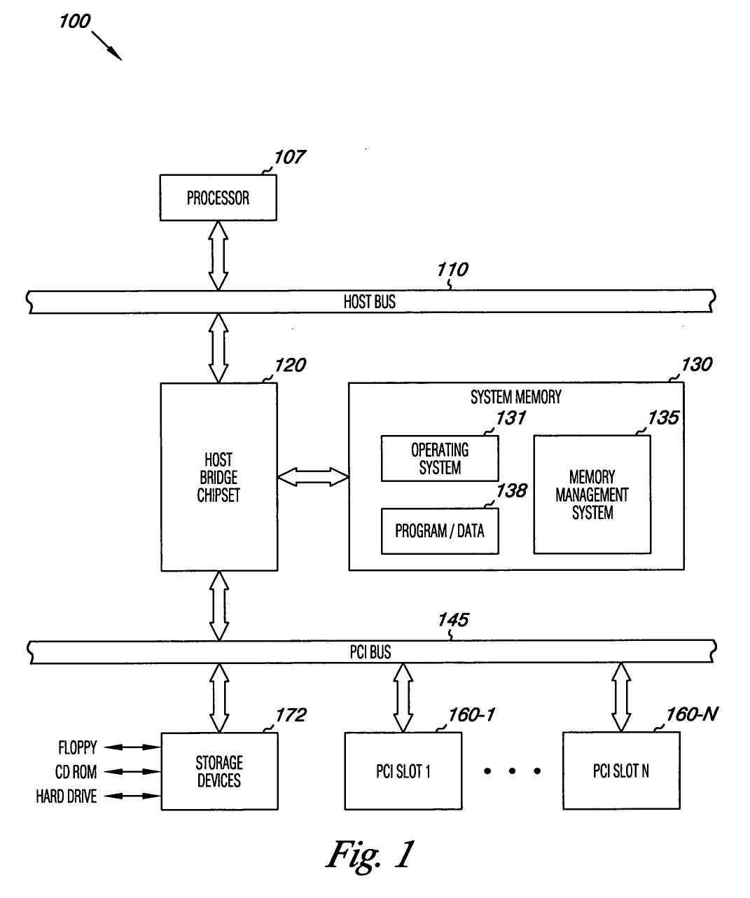

FIG. 1 illustrates an embodiment of a computing device suitable to implement embodiments of the present disclosure. The system or computing device 100 shown illustrates a processor 107, a host bus 110, a host bridge chipset 120, a system memory 130, a peripheral component interconnect (PCI) bus 145, “N” (representing a scalable number) PCI slots 160-1 to 160-N (e.g., slots for I/O circuit cards, controller cards, and other removable devices), and one or more storage devices (e.g., disks, CDs, hard drives, removable memory, etc.), shown generally as 172.

The processor 107 represents a processing unit of various architectures. Embodiments of the disclosure can be implemented in a multi-processor or single processor system or computing device. Embodiments described herein can similarly be implemented in a distributed computing network environment, as the same are known and understood by one of ordinary skill in the art. The embodiments are not limited to the examples given herein.

The host bridge chipset 120 includes a number of interface circuits to allow the host processor 107 to access the system memory 130 and the PCI bus 145. The system memory 130 represents one or more mechanisms for storing information. For example, the system memory 130 may include non-volatile and/or volatile memories. Examples of these memories include flash memory, read only memory (ROM), random access memory (RAM), etc. The system memory 130 may be loaded with an operating system (OS) 131, e.g., in ROM. A basic input/output system (BIOS) is stored in ROM in the system memory 130. Examples of operating systems include, but are not limited to, Windows, Mac, Unix, Linux, etc. The system memory 130 further includes a memory management system 135, e.g., in RAM, and other programs and data 138. The memory management system 135 includes the virtual memory subsystem associated with a given operating system 131 and, as mentioned above, the virtual memory subsystem is capable of generating and maintaining descriptors (unique or otherwise), i.e., space ids, associated with each virtual memory address. The system memory 130 may also contain additional software as the same will be known and understood by one of ordinary skill in the art. The memory management system 135 includes elements such as virtual memory data structures associated with various processes to support the management of memory in connection with program applications being executed by the processor 107. That is, as one of ordinary skill in the art will appreciate, the memory management system includes programs, code, data, look-up tables, etc.

The PCI slots 160-1 to 160-N provide interfaces to PCI devices. Examples of PCI devices can include printers, removable disk storage and databases, facsimiles, scanners, network interface devices, media interface devices, etc. Storage devices 172 can include CD ROMs, databases, disks, hard drives, etc. Embodiments, however, are not limited to these examples.

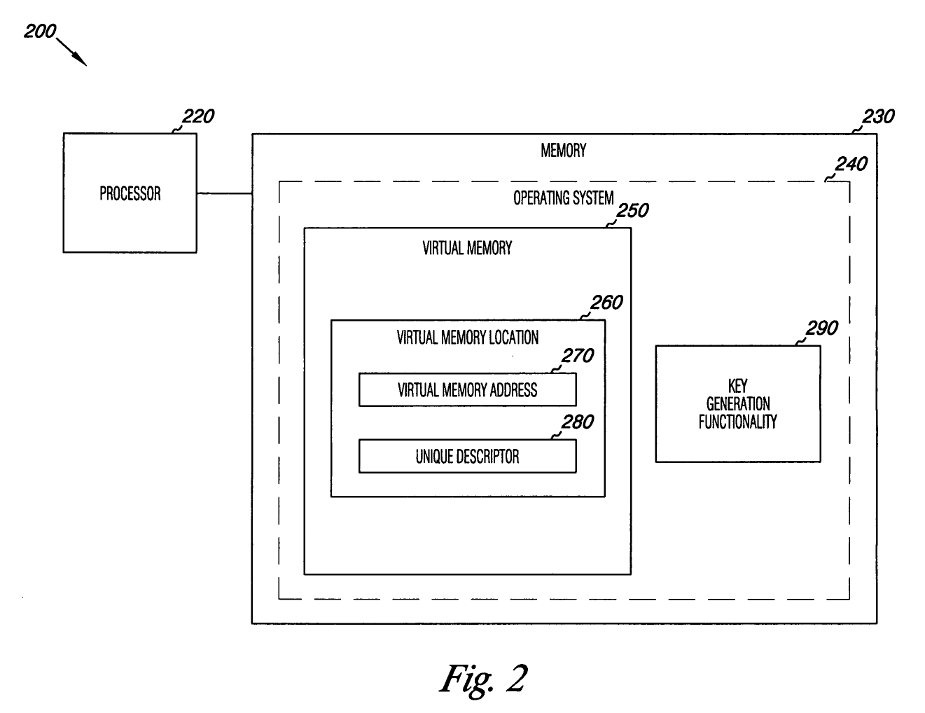

FIG. 2 illustrates a computing device including an embodiment of a key generation functionality that can interact with a virtual memory address and a unique descriptor. In the embodiment shown in FIG. 2, a computing device has a processor and a memory. FIG. 2 shows a computing system 200 with a processor 220 connected to a memory 230. The memory 230 includes a computer readable medium and is capable of storing program instructions and the processor 220 is capable of executing program instructions.

The memory 230 includes an operating system 240, which contains a virtual memory 250 and a key generation functionality 290. The virtual memory 250 includes a virtual memory location 260. A virtual memory address 270 and a unique descriptor 280 are associated with the virtual memory location 260. The key generation functionality 290 is capable of generating a key, for identifying the specific location of the virtual memory location 260 within the virtual memory 250, without locking a virtual address space, by using the virtual memory address 270 and the unique descriptor 280, as described herein.

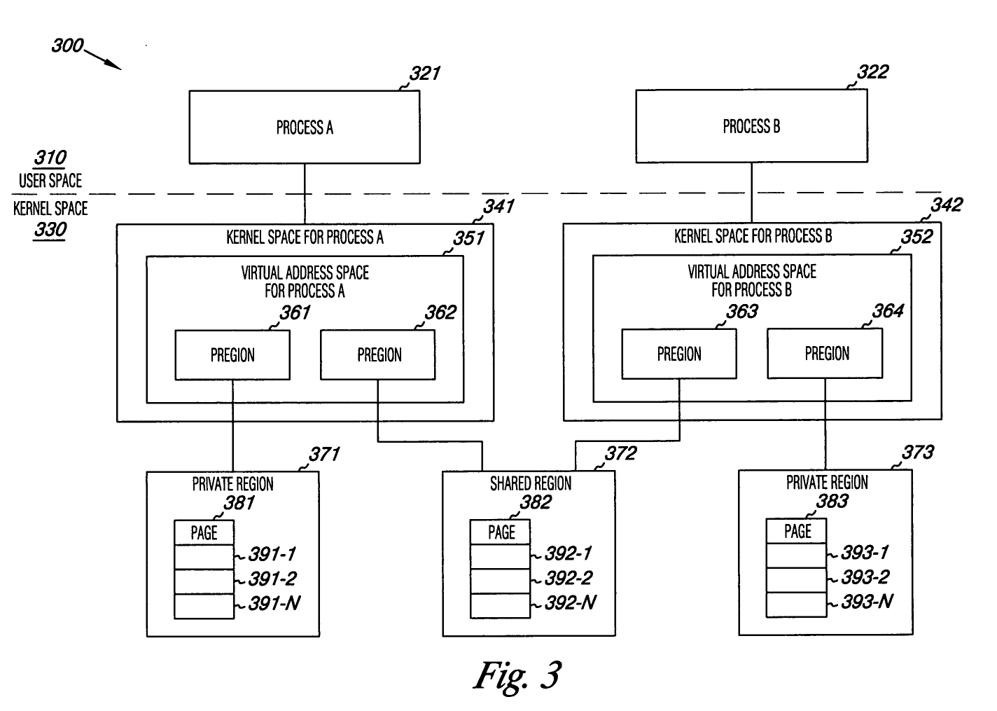

FIG. 3 illustrates a virtual memory structure, including a shared region, suitable to implement embodiments of the present disclosure. In the embodiment shown in FIG. 3, a virtual memory structure has processes in a user space 310 and a kernel space 330. A process A 321 and a process B 322 are software processes. As mentioned above, the kernel layer of a computer system manages the set of processes that are running on the system by ensuring that each process is provided with processor and memory resources at the appropriate time. A process refers to a running program, or application, having a state and which may have an input and output. The kernel provides a set of services that allow processes to interact with the kernel and to simplify the work of an application writer. The process A 321 and the process B 322 each exist in the user space 310 and the kernel space 330. The process A 321 is associated with a kernel space for process A 341 in the kernel space 330. The process B 322 is associated with a kernel space for process B 342 in the kernel space 330.

In the embodiment shown in FIG. 3, the kernel spaces for the processes include virtual address spaces that contain pregions. The kernel space for process A 341 includes a virtual address space for process A 351. The virtual address space for the process A 351 contains a pregion 361 and a pregion 362. The pregion 361 is associated with a private region 371 and contains virtual addresses assigned to virtual memory locations in the private region 371. The pregion 362 is associated with a shared region 372 and contains virtual addresses assigned to virtual memory locations in the shared region 372. The kernel space for process B 342 includes a virtual address space for process B 352. The virtual address space for process B 352 contains a pregion 363 and a pregion 364. The pregion 363 is also associated with the shared region 372 and contains virtual addresses assigned to the virtual memory locations in the shared region 372. The pregion 364 is associated with a private region 373 and contains virtual addresses assigned to virtual memory locations in the private region 373.

In the embodiment shown in FIG. 3, the regions contain pages with virtual memory locations and descriptors. The private region 371 contains a page 381. The page 381 includes private virtual memory locations. Unique descriptors 391-1, 391-2, and 391-N are assigned to the private virtual memory locations in the page 381. The shared region 372 contains a page 382. The page 382 includes shared virtual memory locations. Unique descriptors 392-1, 392-2, and 392-N are assigned to the shared virtual memory locations in page 382. The private region 373 contains a page 383. The page 383 includes private virtual memory locations. Unique descriptors 393-1, 393-2, and 393-N are assigned to the private virtual memory locations in the page 383.

In the embodiment of FIG. 3, program instructions can execute to generate a key for a virtual memory location by using a virtual memory address and a unique descriptor assigned to the virtual memory location. In various embodiments, program instructions can also execute to generate a key by using a virtual memory address and a unique descriptor associated with a virtual memory location. In the embodiment of FIG. 3, program instructions can execute to select a virtual memory location from the virtual memory structure 300. Since, in the embodiment of FIG. 3, virtual memory addresses and unique descriptors are assigned to both private virtual memory locations and shared virtual memory locations in the virtual memory structure 300, program instructions can execute to generate a key for a virtual memory location selected from the private regions 371 or 373 or from the shared region 372.

In one embodiment, program instructions can execute to generate a two-part key. Program instructions can execute to generate a first part of the two-part key, so that the first part is a value or expression that represents a virtual memory address assigned to a selected virtual memory location. Program instructions can also execute to generate a second part of the two-part key, so that the second part is a value or expression that represents a unique descriptor assigned to the selected virtual memory location. In this embodiment, the two-part key includes the first part and the second part.

For example, in the embodiment of FIG. 3, if a first part of a key represents a virtual memory address assigned to a particular virtual memory location in the private region 371, and if a second part of a key represents a unique descriptor for that same particular virtual memory location, then program instructions can execute to generate a two-part key from the first part of the key and the second part of the key. In effect, the two-part key is a tuple (e.g., a space id, virtual address) type key. In this example, such a two-part key can identify or describe the specific location of that particular virtual memory location in the private region 371. This two-part key allows program instructions to identify or describe the specific location of that particular memory location without searching through the virtual address space for process A to locate the corresponding pregion. Since program instructions do not have to search through the virtual address space, the virtual address space does not have to be locked to prevent data in the virtual memory from being changed and/or moved. As a result, program instructions can execute to generate such a two-part key without locking a virtual address space.

In various embodiments, a value in a key can be a numerical value. The numerical value can be in a number of different formats such as binary, hexadecimal, or some other format. The numerical value also can be a number of different sizes, such as a byte value, a multibyte value, or some other size. Embodiments are not limited to these examples.

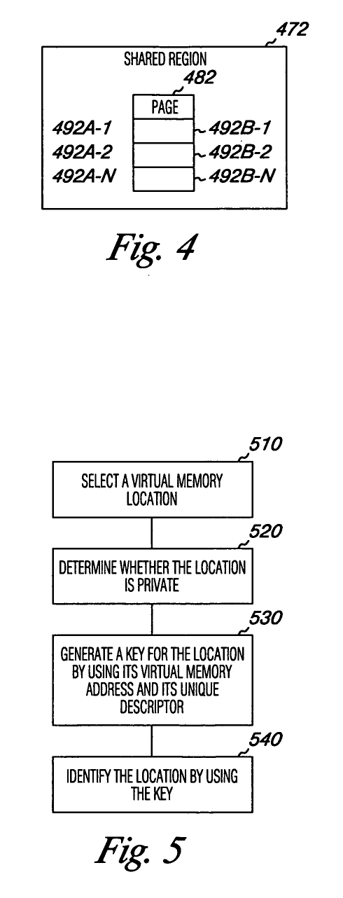

FIG. 4 illustrates an example of a shared region without a unique descriptor. In the embodiment shown in FIG. 4, a shared region contains a page with virtual memory locations and descriptors. The shared region 472 contains a page 482. The page 482 includes shared virtual memory locations. Descriptors 492A-1, 492A-2, 492A-N, 492B-1, 492B-2, and 492B-N are assigned to the shared virtual memory locations in the page 482. The descriptors 492A-1 and 492B-1 describe the same shared virtual memory location. The descriptors 492A-2 and 492B-2 describe the same shared virtual memory location. The descriptors 492A-N and 492B-N describe the same shared virtual memory location.

In the embodiment of FIG. 4, program instructions can execute to generate a key for a virtual memory location by using a virtual memory address and a unique descriptor assigned to the virtual memory location. In the embodiment of FIG. 4, virtual memory addresses are assigned to the shared virtual memory locations. However, in this embodiment, the descriptors assigned to the shared virtual memory locations may not be unique descriptors. Since, in this embodiment, unique descriptors are not assigned to the shared virtual memory locations, program instructions that execute to generate a key by using a unique descriptor assigned to a virtual memory location, cannot execute to generate a key for a shared virtual memory location.

In the virtual memory of some computing devices, private virtual memory locations have unique descriptors, but shared virtual memory locations may not have unique descriptors. In these devices, program instructions that execute to generate a key by using a unique descriptor assigned to a virtual memory location, cannot execute to generate a key for a shared virtual memory location. Since such program instructions use unique descriptors to execute to generate a key, it can be useful to determine whether a virtual memory location selected from such a device is a private virtual memory location.

In various embodiments, program instructions can execute to determine whether a selected virtual memory location is a private virtual memory location. In one embodiment, a record maintains data about whether a virtual memory location is a private virtual memory location. In this embodiment, such a record can be a library, a file, a table, and/or some other type of record, in a system memory, an operating system, a kernel, and/or some other type of record storage. In this embodiment, the program instructions can execute to determine whether a selected virtual memory location is a private virtual memory location by directly or indirectly using the data maintained in the record.

In another embodiment, a record maintains data about whether a virtual memory location is a private virtual memory location and the record is capable of providing an indicator to program instructions. In this embodiment, such an indicator can be a flag, data, an instruction, and/or some other type of indicator. In this embodiment, the program instructions can execute to determine whether a selected virtual memory location is a private virtual memory location by receiving an indicator provided by the record.

FIG. 5 is a block diagram of a method embodiment. Unless explicitly stated, the method embodiments described herein are not constrained to a particular order or sequence. Additionally, some of the described method embodiments or elements thereof can occur or be performed at the same point in time.

The embodiments described herein can be performed by software and/or firmware (i.e., computer executable instructions), hardware, application modules, and the like, executable and/or resident on the systems and devices shown herein or otherwise. The embodiments of the invention are not limited to any particular operating environment or to instructions written in a particular programming language. Software, firmware, and/or processing modules, suitable for carrying out embodiments of the present invention, can be resident in one or more devices or locations. Processing modules can include separate modules connected together or include several modules on an application specific integrated circuit (ASIC).

In the embodiment shown in FIG. 5, a block diagram shows various acts in one embodiment of a method of the present disclosure. As shown at block 510, the method includes selecting a virtual memory location from a virtual memory. Selecting a virtual memory location can be performed by executing program instructions as described in connection with FIG. 3. As shown at block 520, the method includes determining whether the selected virtual memory location is a private virtual memory location. According to various embodiments and as discussed in connection with FIG. 4, program instructions can be executed to determine whether the selected virtual memory location is a private memory location. As shown at block 530, the method includes generating a key for identifying the selected virtual memory location by using its virtual memory address and its unique descriptor. Program instructions as described herein are executable to generate key, using a virtual memory address and a unique descriptor, for identifying a selected virtual memory location. As shown at block 540, the method includes identifying the virtual memory location for which the key was generated, by using the key. As described in connection with FIGS. 2 and 3, in various embodiments of the method, program instructions can execute to use the generated key to identify the virtual memory location. In various embodiments, program instructions can execute to perform each of the acts represented in FIG. 5, as described herein.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for generating a key, comprising:
selecting a virtual memory location, having assigned thereto;
a virtual memory address; and
a unique descriptor; and
generating a key for identifying the virtual memory location using:
the virtual memory address; and
the unique descriptor.

2. The method of claim 1, wherein the method includes:
generating a first part of the key that represents the virtual memory address; and
generating a second part of the key that represents the unique descriptor.

3. The method of claim 2, wherein the method includes identifying the virtual memory location by using the key.

4. The method of claim 2, wherein the method includes accessing the virtual memory location by using the key.

5. The method of claim 1, wherein the method includes selecting the virtual memory location from a virtual memory that includes:
a shared virtual memory location; and
a private virtual memory location.

6. The method of claim 5, wherein the method includes:
determining whether the virtual memory location is a private virtual memory location; and
if the virtual memory location is a private virtual memory location, generating the key.

7. The method of claim 6, wherein the method includes:
maintaining in a record, data about whether the virtual memory location is a private virtual memory location; and
determining whether the virtual memory location is a private virtual memory location by using the data maintained in the record.

8. The method of claim 6, wherein the method includes:
maintaining in a record, data about whether the virtual memory location is a private virtual memory location; and
determining whether the virtual memory location is a private virtual memory location by receiving an indicator from the record.

9. A computer readable medium having instructions for causing a device to perform a method, comprising:
associating a virtual memory address and a unique descriptor with a virtual memory location;
generating a key for describing the virtual memory location by using the virtual memory address and the unique descriptor; and
generating the key includes:
generating a first part of the key that represents the virtual memory address; and
generating a second part of the key that represents the unique descriptor.

10. The medium of claim 9, the method including selecting the virtual memory location from a virtual memory that includes:
a shared virtual memory location; and
a private virtual memory location, having associated therewith:
a virtual memory address; and
a unique descriptor.

11. The medium of claim 9, the method including:
determining whether the virtual memory location is a private virtual memory location; and
if the virtual memory location is a private virtual memory location, generating the key.

12. The medium of claim 11, the method including determining whether a virtual memory location is a private virtual memory location by using data maintained in a library.

13. The medium of claim 11, the method including determining whether a virtual memory location is a private virtual memory location by receiving a flag from a library.

14. A computing device, comprising:
a processor;
a memory, connected to the processor; and
program instructions storable in the memory and executable by the processor to generate a key for identifying a virtual memory location by using a virtual memory address and a unique descriptor.

15. The device of claim 14, including program instructions that execute to identify the virtual memory location by using the key.

16. The device of claim 15, including program instructions that execute to establish the unique descriptor as a numerical value.

17. The device of claim 16, including program instructions that execute to establish the numerical value as a multibyte value.

18. A computing device, comprising:
a processor;
a memory, connected to the processor; and
means for accessing a virtual memory location by using a virtual memory address and a unique descriptor.

19. The device of claim 18, wherein the means for accessing the virtual memory location can be generated while a virtual address space that corresponds with the virtual memory location remains unlocked.

20. The device of claim 18, including means for determining whether the virtual memory location is a private memory location.
